(19) United States
(12) Patent Application Publication
(10) Pub. No.: US 2009/0000144 A1
(43) Pub. Date: Jan. 1, 2009

(54) Method of and an Apparatus for Drying Solid Materials and Mixtures of Solid Materials

(76) Inventor: Eero Berg, Varkaus (FI)

Correspondence Address: HESLIN ROTHENBERG FARLEY & MESITI PC, 5 COLUMBIA CIRCLE, ALBANY, NY, 12203, US

(21) Appl. No.: 11/576,782

(22) PCT Filed: Sep. 30, 2005
(86) PCT No.: PCT/FI05/00418

§ 371 Date: Apr. 5, 2007

(30) Foreign Application Priority Data
Oct. 8, 2004 (FI) 20041309

(51) Int. Cl. F26B 19/00

(52) U.S. Cl. 34/218

(57) ABSTRACT

A method of and an apparatus for drying solid materials and material mixtures in a dryer, comprising a drying space, which is divided by wall elements into drying passages in such a way that each drying passage is limited into two wall elements. Material to be dried is supplied to the drying passages through the upper part thereof. Drying gas is supplied to the drying passages through a first wall element limiting them and moist drying gas is led out of the drying passage to a second wall element limiting them. The dried material is discharged from the drying passages through the lower part thereof. Adjacent wall elements are moved relative to each other in connection with the emptying of the drying passages.

### CROSS REFERENCE TO RELATED APPLICATIONS

This application is a Section 371 filing of International Application No. PCT/FI2005/000418 filed on Sep. 30, 2005, and published as WO 2006/037840 on Apr. 13, 2006, which claims priority from Finnish Application No. FI20041309 filed on Oct. 8, 2004. These applications are hereby incorporated by reference in their entirety.

### TECHNICAL FIELD

The present invention relates to a method of and an apparatus for drying solid materials and mixtures of solid materials defined by the preambles of the independent claims disclosed below.

### BACKGROUND AND SUMMARY OF ASPECTS OF THE INVENTION

Many solid fuels, such as especially biofuels, must be dried before their actual usage as fuel. Biofuels are typically dried with hot gas in drum dryers or fluidized bed dryers. Drying takes place in these apparatuses at a relatively high temperature, typically at 175 to 500° C. For example, hot flue gases or fired steam is thereby used as drying gas. To produce hot flue gases or steam, it is necessary to combust a fuel, such as part of the dried bio fuel or by combusting oil or some other fuel available, such as bark. It would be desirable to be able to dry solid fuels, such as said bio fuels, by utilizing less expensive heat, i.e. at lower temperatures, whereby, for example, waste heat from the processes may be utilized in drying.

Drying at low temperatures requires a longer retention time in the dryer for the material to be dried, whereby the size of the dryer easily increases very much. The great outer dimensions of the dryer are also a result of a typical solution, in which the material to be dried is spread as a continuous bed, through which drying gas is blown.

Since it is usually advantageous to arrange the drying apparatus close to a heat source and destination of the dried material, and since it is often necessary to locate the drier next to the existing apparatuses, a drier of small outer dimensions would be preferable.

It is an object of the present invention to provide an improved method of and an apparatus for drying solid materials or mixtures of solid materials.

It is thereby especially an object of the invention to provide an improved method of and an apparatus for drying viscous materials and material mixtures

Moreover, it is an object to provide a method and an apparatus, which can utilize low temperature heat sources.

It is also an object to provide an apparatus of an advantageous size for drying solid materials, typically fuels.

It is yet another object to provide a reliable and easily controllable apparatus for drying solid materials.

A method of and an apparatus for drying solid materials or material mixtures in accordance with the above mentioned principles are characterized in what is defined below in the characterizing parts of the independent claims.

A typical apparatus for drying solid materials or material mixtures in accordance with the invention comprises at least
a drying space,
one or preferably more partitions dividing the drying space into two or preferably more, typically vertical drying passages, in which the material to be dried is dried by means of drying gas,
supply or filling equipment for feeding the material to be dried to the drying passages, and
discharge means for the discharge of the material dried in the drying passages from the dryer.

A typical method in accordance with the invention comprises at least the following subsequent stages:
feeding or filling stage, in other words feeding moist material to be dried to drying passages;
drying stage, in other words supplying drying gas to the drying passages for drying the moist material therein, and at the same time discharge of the moist drying gas from the drying passages, and
emptying and discharge stage, in other words emptying at least partially the drying passages and discharge of the dried material from the drier.

Drying gas is typically supplied to the drying passages only during the drying stage. It is possible, if so desired, however, to introduce drying gas to the drying passage also during the filling and/or emptying stages, either during the entire filling and/or emptying or only part of said time. Supplying drying gases to the drying passages at the filling and emptying stages of the passages may thus continue without a break, if it does not disturb the filling and/or emptying.

The partitions formed in the drying space are in the solution in accordance with the invention gas-permeable wall elements, which are mainly formed of two wall surfaces spaced apart from each other. The wall surfaces are typically 1-7 m, more typically 3-4 m, wide, and typically 3-12 m, more typically 5-8 m high. The dimensions of the wall surfaces may, of course, differ from the above-mentioned in different constructions. The wall elements are connected to each other in such a way that there is a gas space between the wall surfaces of the wall elements. The width of the gas space, in other words, the distance of the wall surfaces, is typically 0.1-0.5 m, more typically 0.2-0.4 m.

The wall surfaces of the wall elements, in other words generally both wall surfaces, which are limited to the drying passage are gas-permeable, whereby the gas volume between the wall surfaces is in gas flow connection with both drying passages limited in a wall element.

The wall surfaces are provided with openings, which have a size and shape allowing the gas flow either from the gas volume to the drying passage or from the drying passage to the gas volume, but which do not at least substantially allow the material to be dried to flow to the gas volume between the wall surfaces. The wall surfaces may thus be, for example, perforated plates provided with perforations of a suitable size or louvered or lamella walls provided with openings of suitable shape or size. The width of the drying passages, in other words the distance between wall elements is typically 0.1-1.2 m, more typically 0.4-0.8 m.

A part, usually every other, of the wall elements is arranged to feed drying gas to the drying passages surrounding the wall elements. Another part of the wall elements is arranged to remove moist drying gas from said drying passages. The gas volumes operate thus in the first mentioned wall elements as input channels for drying gas and in the other wall elements as discharge channels for moist gas.

The discharge of the dried material from the drying passage, in other words the emptying of the drying passage, can be arranged to take place in the discharge stage by emptying the whole drying passage either at once or only partially. Correspondingly, the whole drying passage is thereby filled at the filling stage at once or at least partially. In cases, where the whole drying passage is to be emptied at once, the whole material in the passage is dried at one drying stage. In cases where the drying passage is emptied in steps, in other words only partially at each emptying step, the drying of the material to be dried takes place only partially between each emptying step. Thereby, the material dries step by step when flowing downwards. The material dries completely or to a desired dryness only at the lowest level of the drying passage.

The open surface of the wall surfaces can be chosen to be of different size at different levels/steps, in other words such that it is possible to supply at each level an amount of drying gas suitable for the drying of the material to be dried. On the other hand, it is possible to feed different drying gas to different levels/steps, if so desired, for example, drying gas of different temperature or humidity, whereby it is advantageous to divide the drying passage to horizontally separate compartments.

The emptying of the drying passages at least partially takes place by means of gravity. The emptying of the dried material merely by means of gravity is, however, often difficult to control. Part of the material easily sticks to the walls of the drying passage and “arches”, whereby the flowing of the material downwards is slow and incomplete. There are different bonds and friction forces between the wall surface and the material in contact therewith as well as between the single material particles, preventing free flow of the dried material out of the drying passage due to the gravity.

Surprisingly, it has now been noticed that by arranging at least a part of the adjacent wall elements, typically every other, movable relative to each other, a normally hardly flowing dried material is caused to flow much easier than earlier from the drying passages in the discharge stage. When the wall elements are moved relative to each other, the material particles in the drying passage are forced to move relative to each other and also relative to the wall surfaces. The movement between the material particles and between the particles and the wall surfaces generated in accordance with the invention breaks up the bonds between the material particles and between the particles and the wall surfaces. The material thus dried is not able to arch in the drying passage and the downward flow of the material in the drying passage and out of it is improved.

The wall elements are typically arranged in the arrangement in accordance with the invention to be movable parallelly with the surface of the wall surfaces. The vertical freedom of the wall elements to move is thereby typically 0.5-1.5 m. Upright wall elements limited by an upright drying passage, which is filled in from the top and emptied from the bottom, are thereby moved typically vertically. Adjacent wall elements are typically moved alternately relative to each other, at least once at every emptying stage. Optionally can only one of adjacent wall elements be moved, by turns up and town, once or more often during each emptying stage. The wall elements may be moved, if so desired, relative to each other already before the actual emptying stage, if such is appropriate for the filling of the passages.

In one preferred embodiment in accordance with the present invention every other wall element is first vertically moved upwards during the emptying stage. After a short while, the rest of the wall elements are moved in the same way, in other words upwards. It is, of course, possible, if so desired, to move wall elements at the same time, for example, to different directions. It is possible to move wall elements several times relative to each other during each emptying stage. The movements of the wall elements are chosen so as to bring about the necessary movement of material particles relative to the wall surfaces and to each other to promote the emptying of the drying passage.

The drying passages are typically provided of the lower part thereof with closing means, by means of which the drying passages can be closed for the drying and opened for the emptying of the dried material. The closing means can be drying passage specific, for example, inflatable seals, closing plates, or like closing means known as such.

On the other hand, actual closing means are not necessary in the lower part of the drying passages, if a layer of dried material is maintained below the drying passages, which layer is evenly discharged from the lower part thereof below the bottom of the drier.

It is possible to use in the apparatus in accordance with the present invention some conventional filling equipment suitable for the purpose to fill in the drying passage. The filling equipment may be, for example, a chain scraper conveyor. Correspondingly, it is possible to use some conventional discharge apparatus suitable for this purpose to remove the dried material in an apparatus in accordance with the invention, such as a scraper conveyor or some other apparatus, which is applicable for removing dried material evenly throughout the area below the drying passages. The drier may be advantageously insulated, for example, by placing it to a heat insulated closure, box, or the like.

It is possible to use in the apparatus in accordance with the present invention different gases applicable for drying the material to be dried, such as hot air, hot flue gases, hot nitrogen, hot carbondioxide, superheated steam or other gas which is applicable of its content and temperature. The temperature of the drying gas is usually <200° C., typically 50-200° C., more typically 80-120° C. The temperature of the discharge gas, in other words, the humid gas to be discharged, is usually <50° C., typically 20-40° C. The relative end humidity of the drying gas is usually >80%, most preferably close to 100%.

The initial humidity, mass flow and desired end humidity of the material to be dried define the thermal capacity required of the drying gas, in other words the inlet temperature and amount of the drying gas. The heat source available determines in practice the initial temperature of the drying gas.

The solution in accordance with the invention is applicable, for example, for drying different humid solid materials, such as fuels, especially biofuels, such as bark, chips, saw dust or bagasse or raw material of bio-origin, such as wood chips, other granular materials, like sludge grains or de-inking waste generated in manufacture of recycled fibers, or a mixture of some of the above mentioned materials. The material to be dried shall preferably be of such a grain size that a sufficient amount of drying gas is brought to flow through the material to be dried with a moderate, typically <10 kPa, more typically <5 kPa, pressure loss.

By applying the invention it is possible to obtain, for example, following advantages:
it is often possible to utilize low temperature waste heat available in the industry for drying, such as low temperature flue gases, hot air, hot water or steam;
required equipment require less space than before, especially the required basal area is small, when the drying takes place in adjacent narrow passages, and
   the apparatus may be adjusted according to different process conditions, for example, when the flow character, humidity, temperature or amount of the material to be dried varies.

### BRIEF DESCRIPTION OF THE DRAWINGS

The invention is discussed more in detail below, with reference to the accompanying drawings, in which

FIG. 1 schematically illustrates a partly open view of a portion of an exemplary apparatus in accordance with the present invention, vertically sectioned along line BB of FIG. 2 and seen inclined from the top;

FIG. 2 schematically illustrates a horizontal section along line AA of FIG. 1;

FIG. 3 schematically illustrates a partly open view of wall elements of the apparatus of FIG. 1 and the supports thereof to the outer walls of the apparatus, seen inclined from the top;

FIGS. 4-9 schematically illustrate vertical sections of drying passages, wall elements and closing means of said passages of the apparatus of FIG. 1 at different stages of the drying process;

FIGS. 10 and 11 schematically illustrate vertical sectional views of wall elements and closing means in connection therewith in accordance with other embodiments of the invention;

FIG. 12 schematically illustrates a horizontal cross-section of an apparatus in accordance with an exemplary embodiment of the invention;

FIG. 13 schematically illustrates a vertical section of an apparatus in accordance with FIG. 12;

FIGS. 14a-14e schematically illustrate a vertical section of an apparatus in accordance with FIG. 12 at different stages of moving the wall elements.

### DETAILED DESCRIPTION

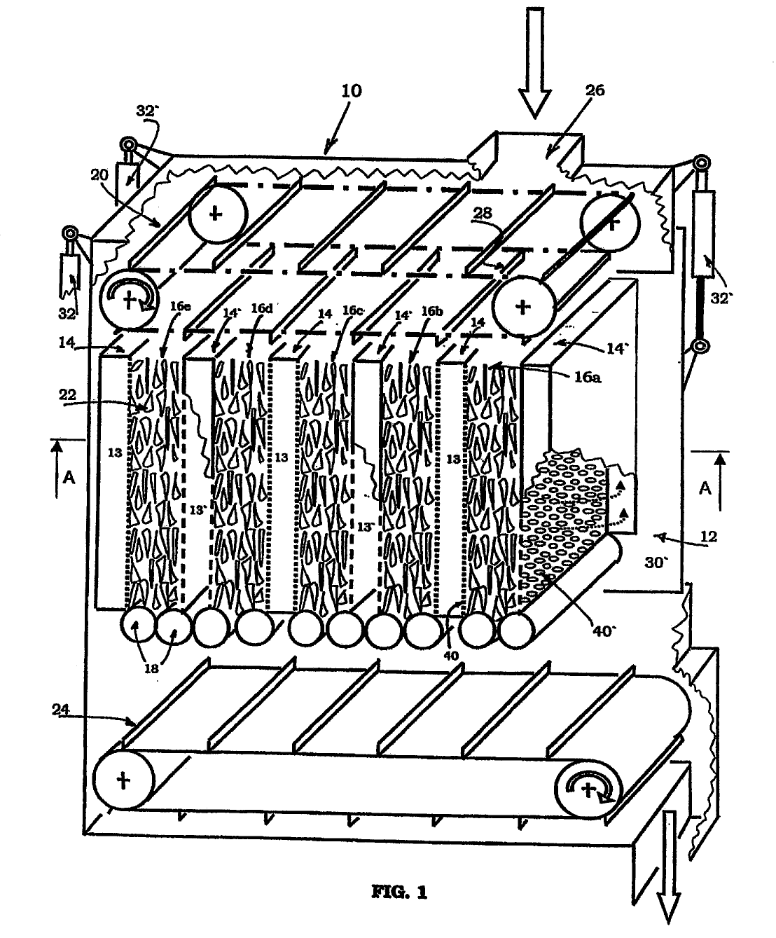

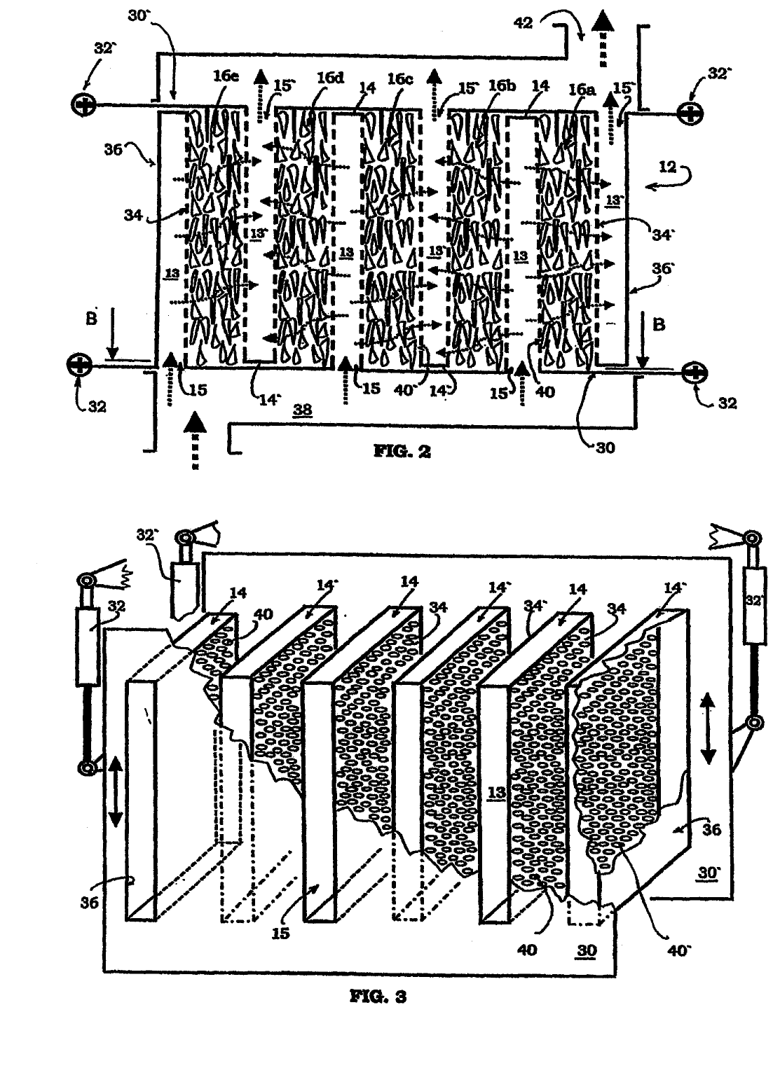

FIGS. 1 and 2 illustrate a drying apparatus, in other words a dryer 10 for solid materials in accordance with the invention. A dryer can be arranged in a heat-insulated box or like. The dryer comprises a drying space 12, to which a number of vertical, from inside open wall elements 14 and 14′ is arranged. The wall elements are positioned adjacently in such a way that they divide the drying space into vertical drying sections or drying passages 16a-16e.

The drying passages 16a-16e are open from above. The bottom openings at the bottom of the passages can be closed. Closing means 18 in FIG. 1 are in closed-position, whereby the material to be dried is not allowed to flow away through the bottom opening of the drying passage. There are two closing means 18 in the disclosed exemplary embodiment in connection with each drying passage. The closing means are attached to the lower edge of the wall elements limiting the passage. The closing means disclosed in the figure are inflatable seals manufactured of flexible, tubular material. When filled the closing means are puffy and close the bottom opening of the drying passages, as illustrated in FIG. 1. Space remains between the emptied, flat closing means allowing the dried material to flow out through the bottom opening of the drying passage.

Filling equipment 20 are arranged above the drying passages 16a-16e and wall elements 14 and 14′, by means of which the drying passages are filled with material 22 to be dried. Discharge equipment 24 is arranged below the drying passages 16a-16e and closing means 18 closing the passages, by means of which the dried material removed from the drying passages can be discharged from the dryer 10.

There is an inlet opening 26 in the drier, through which material is supplied to the filling equipment 20 arranged above the drying passages. The filling equipment 20 is an open chain scraper conveyor in the exemplary embodiment of FIGS. 1-2. In the embodiment of the figure material to be dried is fed through an inlet opening above two first drying passages 16a and 16b. When the drying passages 16a and 16b fill in and material begins to remain above the passages, lower scrapers 28 of the chain scraper conveyor transfer material further to a third drying passage 16c, whereby this fills in, too. After the third passage has filled in, the scrapers 28 transfer material to a fourth passage 16d, etc. until all passages 16a-16e have been filled in and the supply may be stopped. It is possible to arrange a level detector to the last passage, which stops the supply of the material through the inlet opening 26 after the passage has been filled in. FIG. 1 discloses a situation, in which the passages of the dryer have all been filled in with moist granular material and the actual drying, in other words the supply of the drying gas, may begin. If necessary, it is possible to allow a layer of material to be dried, not shown, to be formed on top of the wall elements, too, for example, to prevent the escape of the gas out through the top of the dryer.

It can be seen in FIG. 3 that the wall elements 14 and 14′ are shaped as vertically standing narrow boxes and mainly extend from a movable front wall 30 of the drying space to a rear wall 30′ thereof. The first wall elements 14 are arranged to the dryer interlaced with the other wall elements 14′. It is seen in FIG. 2 and FIG. 3 that every other 14 of the wall elements is stationarily connected with the front wall 30 of the drying space and the remaining wall elements 14′ to the rear wall 30′ of the drying space. The wall elements 14 extend almost to the rear wall 30′, but they are not fixed thereto. Correspondingly, wall elements 14′ extend almost to the front wall 30, but they are not attached thereto. A guide means or seal may be arranged between the wall elements 14 and rear wall 30′, as well as between the wall elements 14′ and the front wall 30. The front wall 30 and the wall elements 14 attached thereto can be moved vertically by means of moving means 32, i.e. up and down between the filling and emptying equipments. The rear wall 30′ and wall elements 14′ attached thereto are correspondingly vertically movable by means of moving means 32′, either at different times or simultaneously.

All wall elements 14 and 14′, except the outermost wall elements, are formed of two perforated plates 34, 34′ in the embodiment illustrated in FIGS. 1 and 2. The outermost wall elements, of which only one side is limited to a drying passage, are formed of one perforated plate and of one solid plate 36. The inner wall of the outermost wall elements is formed by a perforated plate 34 and the outermost wall 36 by a solid plate.

The end of the wall element 14 attached to the front wall is provided with an opening or openings 15 for supplying drying gas inside the wall element. Correspondingly, the end of the wall element 14′ attached to the rear wall is provided with an opening 15′ or openings for the discharge of moist gas from the wall element. A gas space 13 remains between the perforated plates. The bottoms of the wall elements 14 are solid, in other words the gas space 13 is closed from the bottom part. A corresponding gas space 13′ is in the embodiment disclosed in the figure open from its bottom part, to allow the exit of the solid grains possibly arriving to the gas space.

Drying gas fed to the dryer is supplied through a gas distribution channel 38 and an opening 15 or openings to every second wall element 14, from which drying gas flows through openings 40 of the perforated plates 34 to drying passages 16a-16e. Moist gas flows from the drying passages to the other wall elements 14′ through openings 40′ in the perforated plates 34′. Moist gas from the wall elements 14′ flows through opening 15′ or openings and discharge channel 42 out of the dryer. The openings 40 and 40′ of the perforated plates 34 and 34′ of the wall elements 14 and 14′ can be of different shape and size.

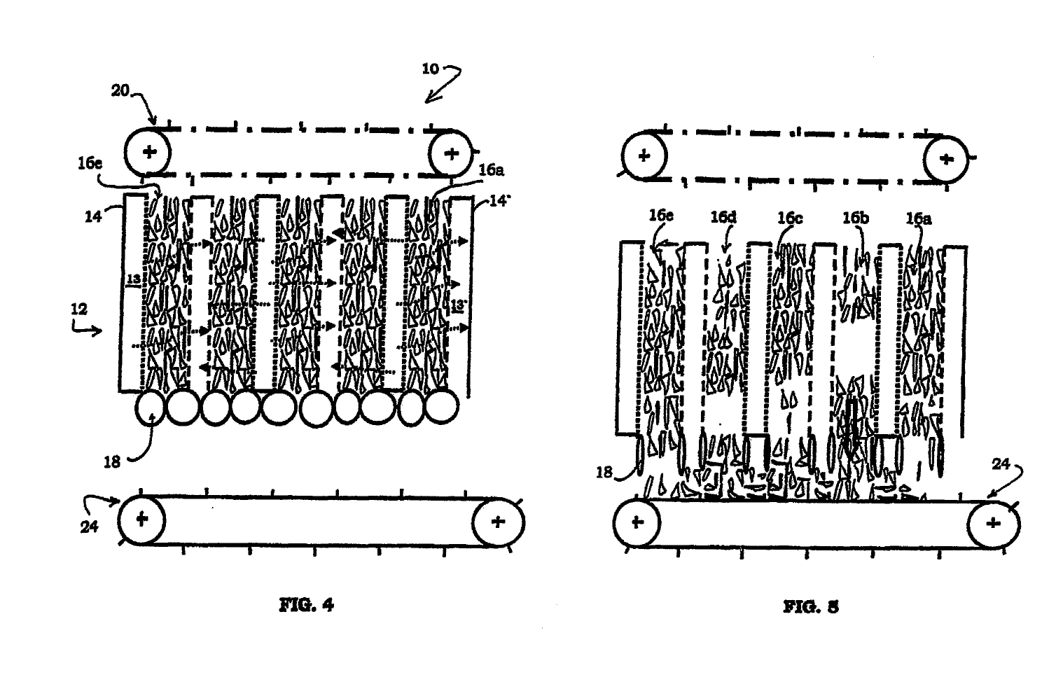

The following figures FIGS. 4-9 briefly disclose the different stages of the drying operation in an exemplary dryer 10. FIG. 4 illustrates stage 1, in which the drying is in progress. The drying passages 16a-16e are filled with material to be dried. Closing means 18 keep the bottom openings of the drying passages closed. Drying gas shown with arrows flows from the gas space 13 of every second of the wall elements 14 to all drying passages 16a-16e. Moist gas from the drying passages flows simultaneously to the gas space 13′ of the wall elements 14′. All wall elements 14, 14′ are at the stage illustrated in the figure at their top position close to the filling equipment 20.

At the second stage shown in FIG. 5, all wall elements 14, 14′ and the material therebetween have been lowered, typically synchronized, down to their lowermost level. The supply of the drying gas has been stopped after a sufficient drying time, in other words after the material to be dried has been dried to a desired end humidity. Inflatable seals acting as closing means 18 have been emptied and the bottom openings of the drying passages have thus been opened. Dried material flows down to the scraper conveyor acting as a discharge apparatus 24. Part of the dried material sticks in the drying passages.

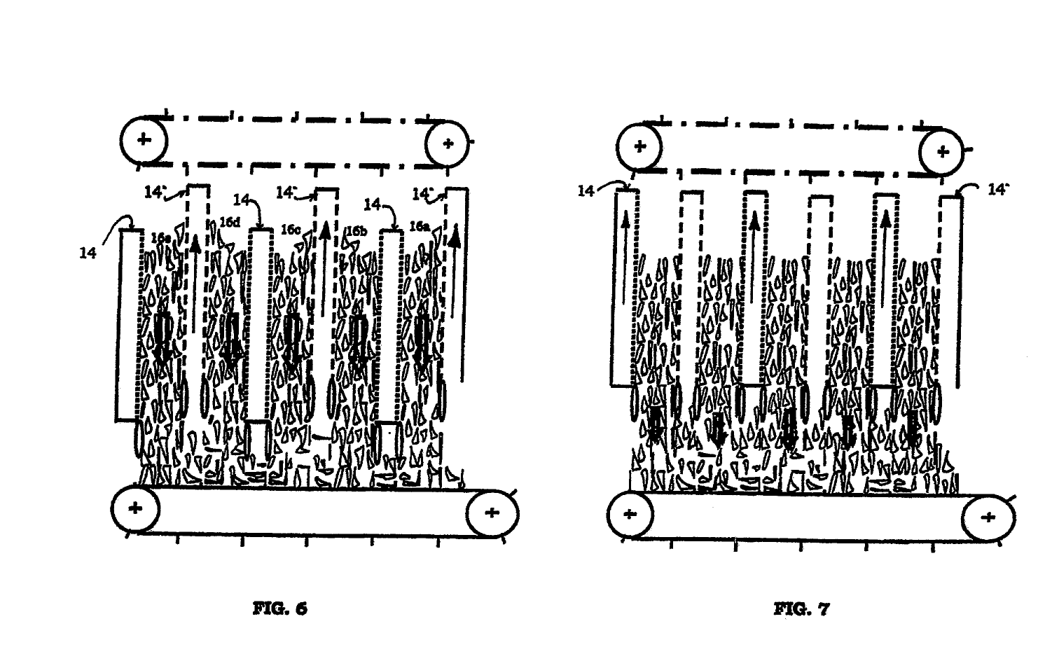

At the third stage illustrated in FIG. 6, every second wall element 14′ has been lifted up, as shown by the arrows, to a higher level than the rest of the wall elements 14. The transfers of the adjacent wall elements relative to one another and the, by the transfers caused, unequal motion of the material in the drying passages 16a-16e breaks bonds between the particles in the material to be dried, whereby the material easily flows downwards and out of the passage. At the fourth stage illustrated in FIG. 7 the other wall elements 14 have also been lifted to a higher level and more material flows out of the drying passages 16a-16e.

At the fifth stage shown in FIG. 8, the drying passages are closed by closing means 18, whereby the emptying of the material has stopped. Thereafter, the discharge apparatus 24 of the dryer has been started. In the exemplary drying process shown in FIGS. 4-9 there is at this point still about two thirds of the drying passage full of material to be dried, which material is dried during the next one, two or more drying stages.

In the case of FIGS. 4-9, the material supplied in stages to the drying passages is dried at several, two to four stages, or even more stages, before it is removed through the lowermost sections of the drying passages as dry as desired. If so desired, the material can be dried at one single stage, whereby the drying passages are filled at once and fully emptied after the drying stage. The scraper conveyor acting as a discharge apparatus 24 removes the dried material from below the drying passages and out of the whole dryer.

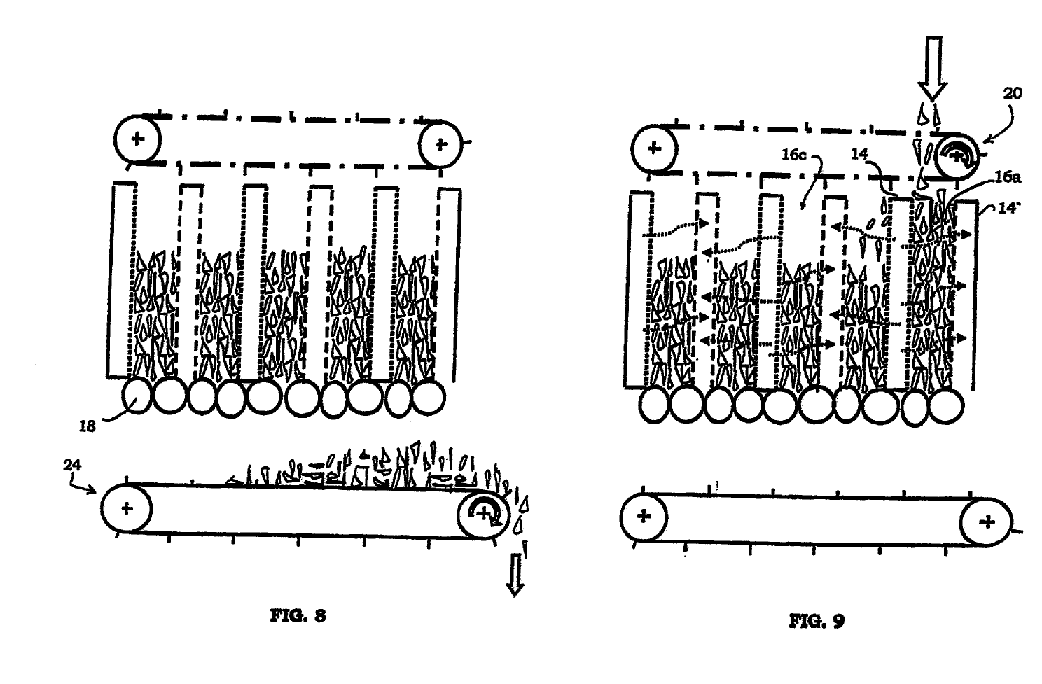

At the sixth stage illustrated in FIG. 9, the filling of the drying passages has started and the first passage 16a has been filled in. At the same time, the supply of the drying gas has been started.

FIG. 10 illustrates a second wall element arrangement, in which wall surfaces 44, 44′ are of lamella structure. The figure illustrates only one drying passage 16 and both wall elements 14, 14′ surrounding said passage. The laminas 45 of the lamella walls support in such a structure the material to be dried, which decreases the tendency of the dried material to collapse.

By the structure of the lamella walls or by adjusting the position of the lamellas 45 thereof, it is possible to adjust air flow to the different heights of the drying passage. The air flow may thus be adjusted, for example, at the lower part of the drying passage different from the upper part thereof, due to the vertically varying flow resistance of the drying gas in the material to be dried.

Closing means are not necessary in the dryers, in which the space below the drying space is not completely emptied after the emptying of the drying passages, as shown in FIG. 10. It is possible to remove dried material with a discharge conveyor only to an extent that leaves a material layer below the passages extending to the lower part of the passages. Thereby, a material layer is left beneath the passages, which prevents the escape of the drying gas from the passages through the bottom. FIG. 10 illustrates a moving hole feeder 48 arranged below the drying passage, by means of which dried material is removed through an opening 46 merely to such an extent from beneath the drying passage 16 that a material layer preventing the escape of the gas remains above the feeder.

In order to remove material from the dryer, it is possible to use some other applicable discharge conveyor instead of a scraper conveyor or a moving hole feeder described above. If so desired it is possible, for example, to use a feeder removing dried material evenly throughout the bottom of the dryer. When wall elements of the drying passages are thereby evenly lowered during the discharge stage and dried material is correspondingly evenly discharged from the dried material bed below the passages throughout the whole bottom in such a way the bed prevents the escape of gas from the passages, closing means are not necessary at the lower end of the drying passages.

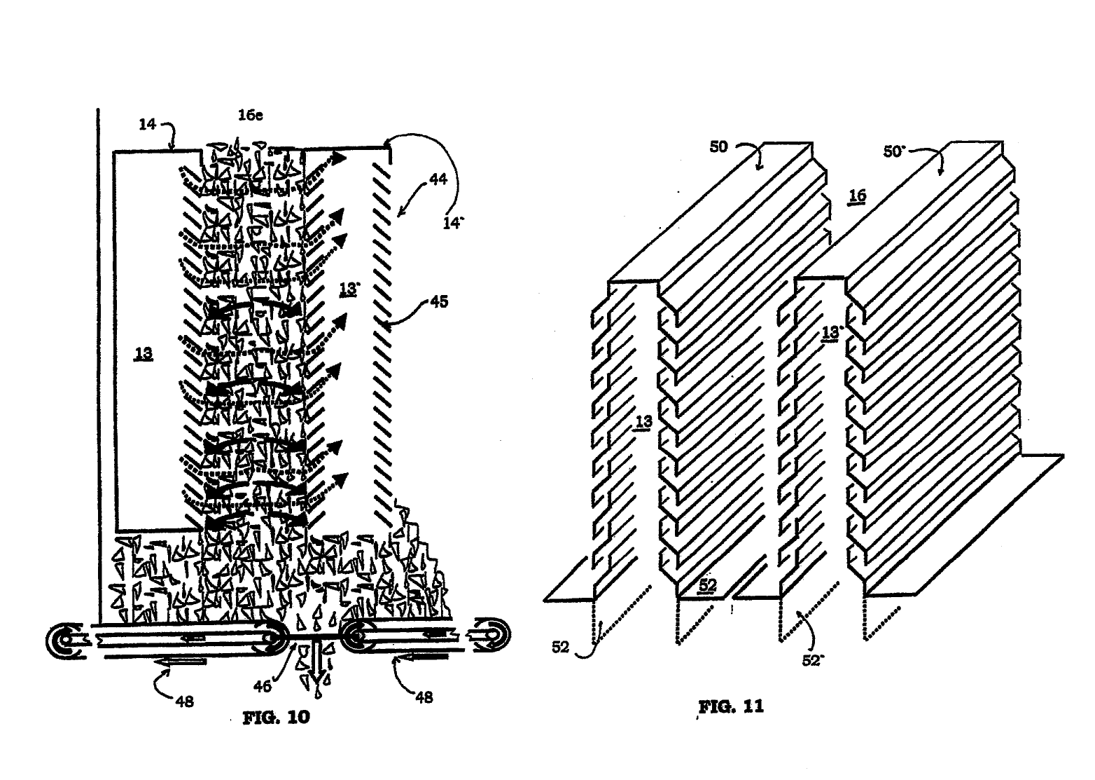

FIG. 11 illustrates a second drying passage 16 limited by lamella walls 50, 50′. Gas flows from the gas space 13 of the lamella wall 50 to the drying passage 16 and from the drying passage 16 to a second lamella wall 50′. Closing plates 52 are arranged to the lower part of the lamella walls limiting the drying passage, which closing plates 52 can be turned horizontal as shown by the figure to close the bottom opening of the drying passage 16. A closing plate 52′ is shown with broken lines as opened, in other words at the emptying stage of the drying passage.

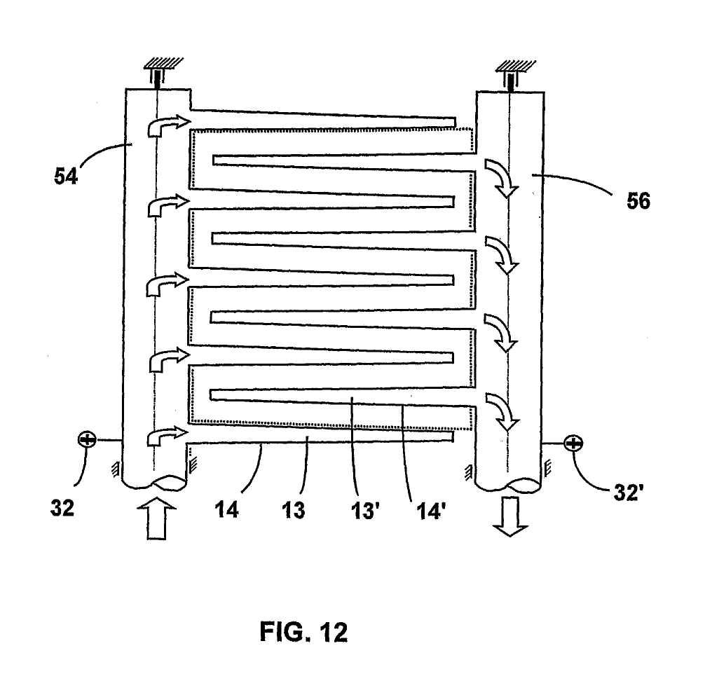

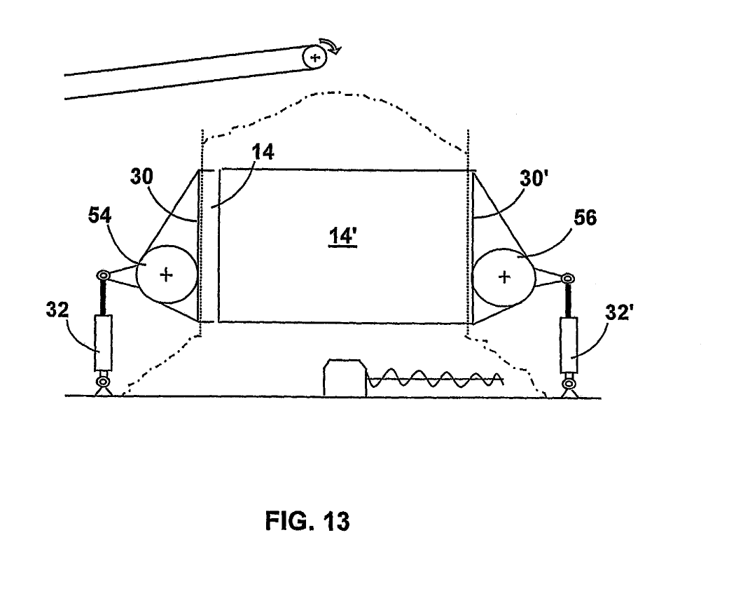

FIGS. 12 and 13 schematically illustrate a horizontal and vertical section of an embodiment of the invention, in which the vertical movement of the wall elements 14, 14′ is provided by rotating the wall elements by moving means, such as hydraulic cylinders 32, 32′ alternately up and down by having horizontal gas distribution and gas discharge channels 54, 56 for drying gas as rotation axes. Thereby the channels 54, 56 are naturally mounted with bearings to turn and the connecting channels (not shown) connecting with the channels are flexible in a reasonable manner.

The gas distribution channel 54 is in gas flow connection with the gas space 13 of the wall elements 14 and the gas discharge channel 56 correspondingly with the gas space 13′ of the wall elements 14′. The wall elements 14 are attached with the vertical front wall 30, the wall elements 14′ correspondingly with the vertical rear wall 30′. The wall elements 30, 30′ are connected with channels 54, 56 in such a solid manner that the wall elements can be lifted up and lowered down by rotating the channels 54 and 56. In the embodiment illustrated in FIG. 12 the wall elements 14, 14′ are narrowing towards the inside of the drier, which contributes to the strengthening of the firmness of the structure.

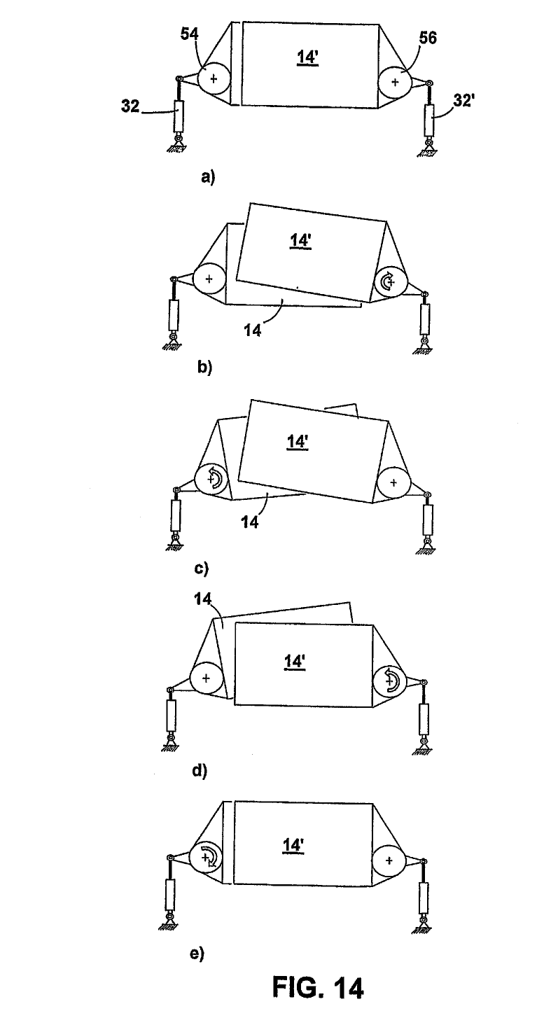

FIGS. 14a-14e schematically illustrate different stages of the emptying process of an exemplary dryer. First, wall elements 14′ are rotated by means 32′ up around the gas discharge channel 56 (FIG. 14b), secondly wall elements 14 are rotated up by means 32 around the gas distribution channel 54 (FIG. 14c), thirdly the wall elements 14′ are lowered down (FIG. 14d) and finally also wall elements 14 are lowered down (FIG. 14 e).

The gas-permeable wall surfaces of the wall elements in the above-disclosed embodiments are formed of a perforated plate or of a lamella. On the other hand, other applicable wall surfaces provided with openings are also possible in the embodiments in accordance with the invention. The surfaces of the wall elements can, for example, in some drying processes be mesh structured surfaces, such as wire surfaces. The wall surfaces can be replaceable in a dryer in accordance with the invention, for example, according to the material to be dried, temperature, drying gas or some other process parameter. The size of the openings in the wall surfaces can be chosen case-by-case. The size of the openings can also differ in different parts of the wall surfaces.

The movable walls of the drying passages may also be inclined. The passage may be downwards narrowing or correspondingly opening, if it is advantageous in view of the flowability of the material to be dried or more even vertical distribution of the drying gas.

The intention is not to limit the invention merely to the exemplary embodiments illustrated above, but to apply the invention broadly within the scope of invention defined in the patent claims below.

1. A method of drying solid material in a dryer, the dryer comprising a drying space divided by wall elements into vertical drying passages wherein the drying passages are limited by two wall elements, the method comprising:
supplying the solid material to the drying passages through an upper part of the drying passages;
supplying a drying gas to the drying passages;
contacting the solid material with the drying gas to produce at least some dried material and a moist drying gas;
discharging the moist drying gas from the drying passages; and
emptying the dried material from the drying passages through the lower part of the drying passages and removing the dried material from the dryer;
wherein the wall elements are hollow;
wherein supplying the drying gas to the drying passages comprises supplying the drying gas through a first hollow wall element;
wherein discharging the moist drying gas from the drying passages comprises discharging the moist drying gas through a second hollow wall element, adjacent to the first hollow wall element; and
wherein emptying the dried material from the drying passages further comprises moving at least one of the first hollow wall element and the second hollow wall element relative to the other in a direction parallel to the surface of the wall elements.

2. Method in accordance with claim 1, wherein the hollow wall elements comprise two spaced gas-permeable wall surfaces providing a gas space between the wall surfaces.

3. Method in accordance with claim 1, wherein moving at least one of the first hollow wall element and the second hollow wall element comprises alternately moving the first hollow wall element and the second hollow wall element.

4. Method in accordance with claim 1, wherein the hollow wall elements are moved in a vertical direction.

5. Method in accordance with claim 1, wherein the wall elements are moved in a vertical direction by rotating relative to a horizontal axis.

6. Method in accordance with claim 1, wherein the drying passages are provided with closing means, and wherein at least part of the closing means are closed during contacting the solids material with the drying gas and opened during emptying the dried material.

7. Method in accordance with claim 1, wherein the drying gas has a temperature less than 200° C., and the moist drying gas is discharged at a temperature of less than 50° C.

8. Method in accordance with claim 1, wherein the drying gas comprises at least one of hot air, hot nitrogen, hot carbon dioxide and hot flue gases.

9. Method in accordance with claim 1, wherein the solid material comprises at least one of biofuel and raw material of bio-origin.

10. An apparatus for drying solid material comprising:
a dryer having a drying space divided by gas-permeable wall elements into vertical drying passages wherein the drying passages are limited by two wall elements;
filling equipment arranged to supply the solid material to the drying passages through an upper part of the drying passages; and
discharge equipment arranged to remove a dried material emptied from the drying passages from the dryer;
wherein the gas permeable wall elements are hollow;
wherein the apparatus further comprises
first hollow wall elements comprising input channels to supply a drying gas to adjacent drying passages; and
second hollow wall elements interlaced with the first hollow wall elements, the second hollow wall elements comprising discharge channels to discharge a moist drying gas from adjacent drying passages; and
wherein at least one of the first hollow wall elements and the second hollow wall elements is movable relative to the other.

11. Apparatus in accordance with claim 10, wherein the hollow wall elements comprise two vertical spaced gas-permeable wall surfaces providing a gas space there between.

12. Apparatus in accordance with claim 10, wherein at least one of the hollow wall elements is movable in a direction parallel to the surface of the hollow wall elements.

13. Apparatus in accordance with claim 10, wherein at least one of the hollow wall elements is movable in a vertical plane by rotating relative to a horizontal axis.

14. Apparatus in accordance with claim 10, wherein the drying passages are provided with closing means adapted to close at least part of the drying passages.

15. Apparatus in accordance with claim 11, wherein the wall surfaces comprise one of perforated plate and lamella structure.

16. Apparatus in accordance with claim 11, wherein the first hollow wall elements are attached to a vertical front wall of the drying space and the second hollow wall elements are attached to a vertical rear wall of the drying space, and wherein at least one of the front and the rear walls is vertically movable.

17. Apparatus in accordance with claim 16, wherein
the gas spaces of the first hollow wall elements are in gas flow connection with a gas distribution channel arranged in connection with the front wall, and
the gas spaces of the second hollow wall elements are in gas flow connection with a gas discharge channel arranged in connection with the rear wall.

18. Method in accordance with claim 9, wherein the biofuel comprises at least one of bark, chips, saw dust, and bagasse, and the raw material of bio-origin comprises at least one of wood chips, sludge grains, and de-inking waste generated in manufacture of recycled fibers.

19. Method in accordance with claim 7, wherein the drying gas has a temperature of 50-200° C., and the moist drying gas is discharged at a temperature of 20-40° C.

20. Apparatus in accordance with claim 10, wherein at least one of the hollow wall elements is movable vertically.
